(19) United States
(12) Patent Application Publication
(10) Pub. No.: US 2011/0055757 A1
(43) Pub. Date: Mar. 3, 2011

(54) COMMUNICATION APPARATUS, METHOD, COMPUTER PROGRAM, AND COMPUTER-READABLE MEDIUM SELECTING GRAPHICAL USER INTERFACE SET-UPS

(75) Inventors: Kichiro KUROZUMI, Malmo (SE); George ARRIOLA, San Francisco, CA (US); Mike BAUERLY, San Francisco, CA (US); Rui YAMAGAMI, San Diego, CA (US); George WILLIAMS, Oakland, CA (US); Takahiro KAWAGUCHI, San Francisco, CA (US)

(73) Assignee: SONY ERICSSON MOBILE COMMUNICATIONS AB, Lund (SE)

(21) Appl. No.: 12/855,269

(22) Filed: Aug. 12, 2010

Related U.S. Application Data
(60) Provisional application No. 61/238,742, filed on Sep. 1, 2009.

(51) Int. Cl. G06F 3/048

(52) U.S. Cl. 715/810

(57) ABSTRACT

A mobile communication apparatus comprising a graphical user interface with a plurality of selectable graphical user interface set-ups, wherein each of the selectable graphical user interface set-ups comprises a graphical set-up to be displayed as a default screen view of a display of the mobile communication apparatus is disclosed. The mobile communication apparatus further comprises a graphical user interface set-up selection mechanism enabling a user pre-set selection criterion for selecting one of the selectable graphical user interface set-ups based on at least one parameter defined by the user pre-set selection criterion. A method and computer program for automatic selection of graphical user interface set-ups, i.e. panels, are disclosed.

### TECHNICAL FIELD

The present invention relates to a communication apparatus. In particular, the invention relates to abilities to select graphical user interface set-ups based on determined situations. The present invention also relates to method, computer program, and computer-readable medium for implementing such selection of graphical user interface set-ups.

### BACKGROUND

Communication apparatuses can have the ability to provide different panels, i.e. graphical user interface set-ups, at certain states of the communication apparatus, such as during stand-by state. The user is able to select, and re-select, the panel. Normally, a large number of panels are available. They can both be provided by the apparatus manufacturer, the communications operator, and by third party providers. Selection and re-selection is normally made by the user enters a settings application, where the desired panel is selected. The selected panel then remains until the user again enters the settings application and selects another one.

Panels are many times very usable to the user by providing extracted information. However, further improvements of the concept are believed to further increase usability of a communication apparatus having panels abilities. It is therefore a desire to provide such improvements.

### SUMMARY

The present invention aims to improve a graphical user interface (GUI) to demands and wishes of a user. The present invention is based on the understanding that selectable GUI set-ups are many times not re-selected to a demand and wish of the user for different situations if it requires an active change of settings made by the user to select. This can be due to the user being occupied with other activities, such as walking, driving a car, etc. The inventor has realized that the user many times has different demands and wishes depending on situations that can be determined by the communication apparatus. The communication apparatus is therefore adapted to make the re-selection of GUI set-up for a default screen view automatically according to a user pre-defined rule in respect of determined situations.

According to a first aspect, there is provided a mobile communication apparatus comprising a graphical user interface with a plurality of selectable graphical user interface set-ups, wherein each of the selectable graphical user interface set-ups comprises a graphical set-up to be displayed as a default screen view of a display of the mobile communication apparatus. The mobile communication apparatus further comprises a graphical user interface set-up selection mechanism enabling a user pre-set selection criterion for selecting one of the selectable graphical user interface set-ups based on at least one parameter defined by the user pre-set selection criterion.

The at least one parameter may comprise any of a group comprising time of day, date, weekday, weather, position, and messaging service activity.

The graphical set-up may comprise at least one field illustrating data associated with information provided with an associated application of the mobile communication apparatus. The associated application may interact with at least a further application of the mobile communication apparatus, or of a server of a communication network to which the mobile communication apparatus is connected, for providing the data.

According to a second aspect, there is provided a method for a mobile communication apparatus comprising a graphical user interface with a plurality of selectable graphical user interface set-ups, wherein each of the selectable graphical user interface set-ups comprises a graphical set-up to be displayed as a default screen view of a display of the mobile communication apparatus. The method comprises defining a user pre-set selection criterion for selecting one of the selectable graphical user interface set-ups; determining at least one parameter defined by the user pre-set selection criterion; selecting a graphical user interface set-up among the selectable graphical user interface set-ups based on the at least one parameter; and displaying the graphical user interface with a graphical set-up according to the selected graphical user interface set-up.

The at least one parameter may comprise any of a group comprising time of day, date, weekday, weather, position, and messaging service activity.

The graphical set-up may comprise at least one field illustrating data associated with information provided with an associated application of the mobile communication apparatus, wherein the method further comprises a graphical user interface requesting the data from the associated application and receiving the requested data, and the displaying comprises displaying the received data according to the graphical set-up. The associated application may interact with at least a further application of the mobile communication apparatus, or of a server of a communication network to which the mobile communication apparatus is connected, for providing the data.

According to a third aspect, there is provided a computer readable medium comprising program code with instructions arranged to be executed by a processor of a portable electronic device, wherein the instructions cause the portable electronic device to perform the method according to the second aspect.

According to a fourth aspect, there is provided a computer program comprising program code with instructions arranged to be executed by a processor of a portable electronic device, wherein the instructions cause the portable electronic device to perform the method according to the second aspect.

### BRIEF DESCRIPTION OF DRAWINGS

FIG. 1 schematically illustrates a mobile communication apparatus according to an embodiment.

FIG. 2 is a flow chart schematically illustrating a method according to an embodiment.

FIG. 3 schematically illustrates a computer-readable medium according to an embodiment.

FIG. 4 illustrates an exemplary communication apparatus displaying a screen for user setting of rules for panels.

FIG. 5 illustrates an exemplary communication apparatus displaying an alternative screen for user setting of rules for panels.

FIG. 6 illustrates an exemplary communication apparatus displaying a further alternative screen for user setting of rules for panels.

### DETAILED DESCRIPTION

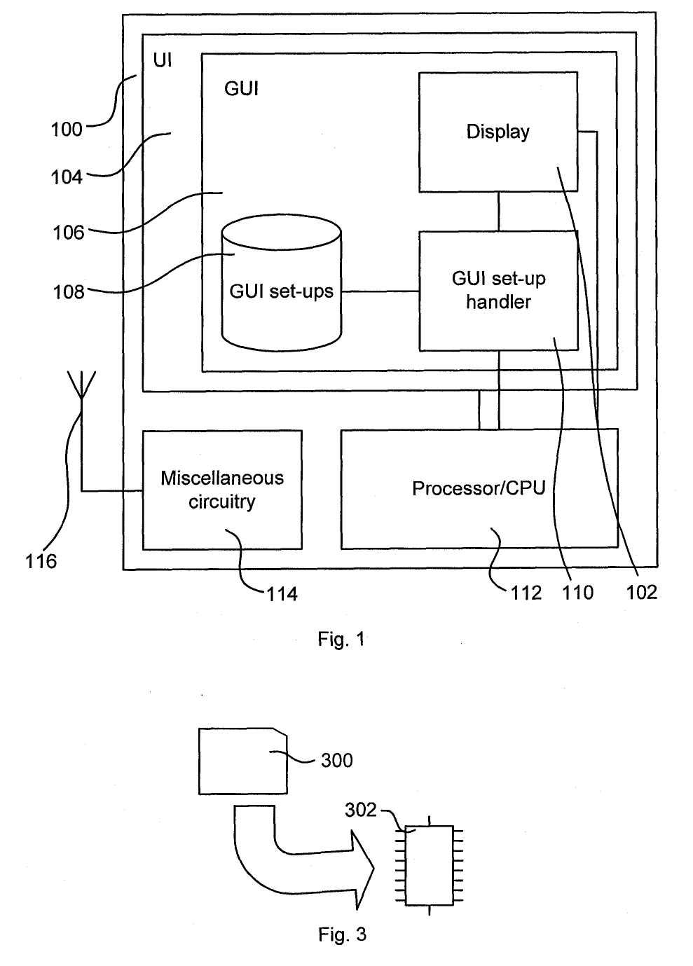

FIG. 1 is a block diagram schematically illustrating a mobile communication apparatus 100 according to an embodiment. It should be noted that the illustration provides a mix between physical and functional elements. Some elements are physical, such as the mobile communication apparatus 100, a display 102, and an antenna arrangement 116. Some elements can be either/both physical or/and functional, such as user interface (UI) 104, GUI 106, GUI set-ups 108, GUI set-up handler 110, processor/central processing unit (CPU) 112, and miscellaneous circuitry 114.

The mobile communication apparatus 100 comprises a UI 104 which is arranged for any interaction between the apparatus 100 and a user of the apparatus 100. The UI 104 can comprise a plurality of elements for input and output, such as microphone, speaker, keys, vibrator, etc. The UI 104 also comprises the GUI 106 which via the display 102 can provide interactions with the user. The mobile communication apparatus 100 also comprises conventional elements of such an apparatus such as the processor/CPU 112, the miscellaneous circuitry 114, and the antenna arrangement 116. The miscellaneous circuitry 114 can comprise elements such as transceiver circuitry, signal processing circuitry, memory, input/output circuitry, etc. as are conventional for mobile communication apparatuses. Not to obscure the gist of the invention, conventional features of the apparatus are not further described here.

The elements can be part of each other, for example the GUI set-up handler 110 can be part of the processor/CPU 112, and the GUI set-ups 108 can be items stored in a memory of the miscellaneous circuitry 114.

The GUI 106 has a default view that is provided on the display 102 when the apparatus 100 is in a stand-by mode, i.e. when the user is not actively using any of the applications of the apparatus, such as making a call, browsing the web, editing messages, etc. The default view comprises one of several graphical user interface set-ups, often called “panels”. A panel can be said to “fillet” out content from the apparatus 100 such that things good or nice to know or see for the user at a quick glance of the screen without specifically opening a particular application can be provided. Different panels can get different content from the apparatus 100 and display it in different ways. Thus, different panels can suit different situations, respectively. A user can of course manually select what panel to show. One panel can for example view a clock, an overview of calendar items for the day/week/month, a weather forecast, and today's date. Another panel can view a slide show of selected pictures. A further panel can view a list of latest news and/or latest received messages. A panel can also have sub-panels, i.e. variants of the panel which are selectable for example from tabs of the panel. Each displayed field/element of the panel is preferably associated to an application providing the content to be viewed. Taking the first mentioned example of panel, the viewed clock receives the time from a clock application, the viewed calendar overview receives the content from a calendar application, the viewed weather forecast receives weather data from an application gaining the information by accessing a suitable service on the web, and the view of the date preferably receives the information also from the calendar application. An application associated with viewed data can in turn call further applications to collect the data. For example, the slide show application can call a content collection application and a multimedia application.

Now, with the nature of GUI set-up and the presence of several such selectable panels in mind, it has been found by the inventor that a user of a mobile communication apparatus with such abilities many times re-selects panel as a way of just getting a new fresh default view of the apparatus, although the ability gives more value than that. For example, in the morning, a panel giving latest news and a weather forecast together with a big and clear clock view is optimal, while during the work day, a panel with a clock, an overview of calendar items for the day/week/month, latest messages, and today's date is optimal. During the time on the train home, the best panel can be a multimedia panel with associated applications such as FM-radio and/or music player is preferable, and at the free time at home, the panel giving latest news and a weather forecast together with a big and clear clock is preferred. If being on a business trip, the evening panel can be with a slide show of pictures of family members, etc. The panels can be automatically chosen by the apparatus 100 based on a determined situation. It can be a situation determination only based on the time of day which for a day as given as example above mostly is predictable. Other parameters, such as a position given by a positioning application, e.g. GPS, of the apparatus 100 can also be used to determine the situation, such as determining whether at home, on the move towards work, at work, on the move towards home, or far away from home, as given in the examples above. A combination of time and position can of course also give the determined situation. Other parameters can be weather, determined from a weather service on the web, messaging activity, e.g. number of friends logged onto a messaging service, or other information that is determinable by the apparatus 100.

The features have been mainly discussed from a user perspective, which of course is the main object, but from a technical perspective, given in a crude hierarchical way, there is a main GUI set-up application, functionally given as the GUI set-up handler 110, calling any of a plurality of panel applications, functionally given as the GUI set-ups 108. The GUI set-up application provides the preferred panel application based on a selection made based on a set of rules that preferably is set by the user. When a panel application is called for a determined situation determined from the set of rules, the panel application calls its associated applications for provision of the information needed for the panel application to provide the desired default view. Here, it is evident that the term “view” is not a static image viewed, but a dynamic view given by the called applications and the panel application which provides processed information for viewing and/or quick access to a selected set of applications. Instead, due to the dynamic behaviour of the features, the GUI set-up handler/GUI set-up application can be seen as a kind of operating system for a stand-by mode of the apparatus. The here given hierarchy is of course a crude description of the interaction, which in practise is more of an interaction between application objects, wherein the applications can play different roles by calling each other for different GUI set-ups.

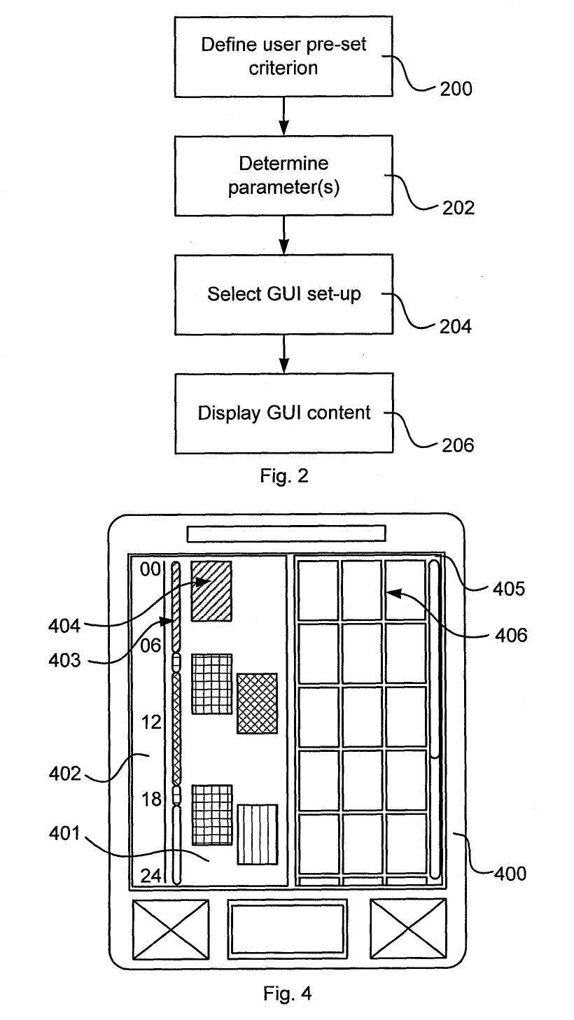

FIG. 2 is a flow chart schematically illustrating a method according to an embodiment. In a user pre-set criterion definition step 200, the user is enabled to set rules for automatic selection of panels, i.e. GUI set-ups. One or more sets of rules can also be provided as a default suggestion to a user. Then, in operation, parameter(s) relevant for the automatic selection is/are determined in a parameter determination step 202. Based on the rules and the determined parameter(s), a GUI set-up, i.e. a panel, is automatically selected in a GUI set-up selection step 204, and GUI content in line with the selected GUI set-up is displayed in a GUI content displaying step 206. It should be understood that the displaying step is performed all the time the communication is in a state where a panel is to be viewed, e.g. stand-by state. The determination of parameter(s) and selection of GUI set-up is made repeatedly to perform the automatic re-selection of GUI set-up. The input of user defined rules is made upon request of the user. Thus, the steps of the flow chart should not be considered as sequential step; they should rather be considered as objects performed on real-time basis.

The method according to the present invention is suitable for implementation with aid of processing means, such as computers and/or processors of the portable electronic devices. Therefore, there is provided computer programs, comprising instructions arranged to cause the processing means or processor of the portable electronic device to perform the steps of the method according to the embodiments described with reference to FIG. 2. The computer program preferably comprise program code which is stored on a computer readable medium 300, as illustrated in FIG. 3, which can be loaded and executed by a processing means or processor 302 of the portable electronic device to cause it to perform the methods, respectively, according to embodiments of the present invention, preferably as the embodiments described with reference to FIG. 2. The processor 302 and computer program product 300 can be arranged to execute the program code sequentially where actions of the any of the methods are performed stepwise, but can also be arranged to perform the actions on a real-time basis, i.e. actions are performed upon request and/or available input data. The processing means or processor 302 is preferably what normally is referred to as an embedded system. Thus, the depicted computer readable medium 300 and processor 302 in FIG. 3 should be construed to be for illustrative purposes only to provide understanding of the principle, and not to be construed as any direct illustration of the elements.

FIG. 4 illustrates an exemplary communication apparatus 400 displaying a screen for user setting of rules for panels. A left side field 401 illustrates a rule setting based on time of day 402 where different panels are booked for different times, as illustrated by bars 403 along a time indicator and illustrations of respective booked panel 404. In a right side field 405 illustrates available panels 406 are viewed such that a user for example can drag and drop the panels to the left field 401 to schedule it for a desired time. Thus, the user is able to add, delete, or change scheduling for different panels.

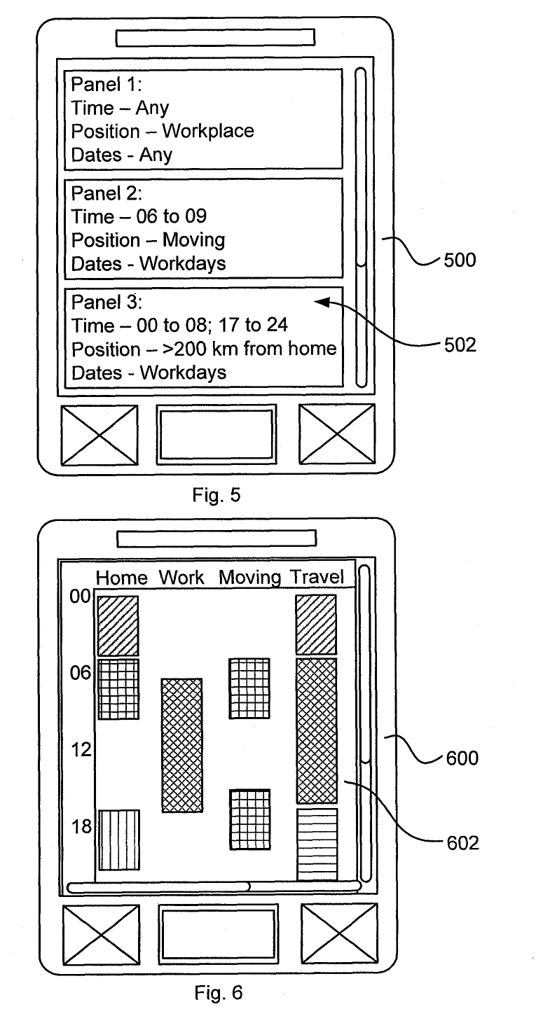

FIG. 5 illustrates an exemplary communication apparatus 500 displaying an alternative screen for user setting of rules for panels. Fields 502 associated with the respective panels are displayed, each together with their assigned rules. The user is able to edit the rules for each panel to achieve a desired behavior of the automatic selection of panels. The rules can define one or more parameters which control whether the panel is to be selected. As elucidated above, when the parameters defined agrees with determined values/states of those parameters, a re-selection of panel occurs, and the panel having the defined parameter(s) is selected and the display provides views according to the corresponding panel when the communication apparatus is in such a state where the panel is presented, i.e. as a default view.

FIG. 6 illustrates an exemplary communication apparatus 600 displaying further an alternative screen for user setting of rules for panels. In a horizontal direction of a rules setting field 602, a parameter based on position is assigned, while in a vertical direction of the rules setting field 602, another parameter based on time of day is assigned. The automatic re-selection of panel can thus be made from the user pre-set rules graphically assigned in the rules setting field. For parts of the field where no panel is assigned, the communication apparatus 600 preferably remain with previous panel, or re-selects a default panel. The panels can be dragged and dropped to the field 602 for example as demonstrated with reference to FIG. 4, or by a dialog box appearing when marking a spot on the field, where the dialog box can comprise panels to enter at the spot, which defines a combination between the parameters of the horizontal and vertical axes. By marking an already set rule, the rule can for example be edited or deleted.

1. A mobile communication apparatus comprising a graphical user interface with a plurality of selectable graphical user interface set-ups, wherein each of the selectable graphical user interface set-ups comprises a graphical set-up to be displayed as a default screen view of a display of the mobile communication apparatus, the mobile communication apparatus further comprising a graphical user interface set-up selection mechanism enabling a user pre-set selection criterion for selecting one of the selectable graphical user interface set-ups based on at least one parameter defined by the user pre-set selection criterion.

2. The mobile communication apparatus according to claim 1, wherein the at least one parameter comprises any of a group comprising time of day, date, weekday, weather, position, and messaging service activity.

3. The mobile communication apparatus according to claim 1, wherein the graphical set-up comprises at least one field illustrating data associated with information provided with an associated application of the mobile communication apparatus.

4. The mobile communication apparatus according to claim 3, wherein the associated application interacts with at least a further application of the mobile communication apparatus, or of a server of a communication network to which the mobile communication apparatus is connected, for providing the data.

5. A method for a mobile communication apparatus comprising a graphical user interface with a plurality of selectable graphical user interface set-ups, wherein each of the selectable graphical user interface set-ups comprises a graphical set-up to be displayed as a default screen view of a display of the mobile communication apparatus, the method comprising
defining a user pre-set selection criterion for selecting one of the selectable graphical user interface set-ups;
determining at least one parameter defined by the user pre-set selection criterion;
selecting a graphical user interface set-up among the selectable graphical user interface set-ups based on the at least one parameter; and
displaying the graphical user interface with a graphical set-up according to the selected graphical user interface set-up.

6. The method according to claim 5, wherein the at least one parameter comprises any of a group comprising time of day, date, weekday, weather, position, and messaging service activity.

7. The method according to claim 1, wherein the graphical set-up comprises at least one field illustrating data associated with information provided with an associated application of the mobile communication apparatus, wherein the method further comprises a graphical user interface requesting the data from the associated application and receiving the requested data, and the displaying comprises displaying the received data according to the graphical set-up.

8. The method according to claim 7, wherein the associated application interacts with at least a further application of the mobile communication apparatus, or of a server of a communication network to which the mobile communication apparatus is connected, for providing the data.

9. A computer readable medium comprising program code with instructions arranged to be executed by a processor of a portable electronic device, wherein the instructions cause the portable electronic device to perform the method according to claim 5.

10. A computer program comprising program code with instructions arranged to be executed by a processor of a portable electronic device, wherein the instructions cause the portable electronic device to perform the method according to claim 5.
